(19) United States
(12) Patent Application Publication
(10) Pub. No.: US 2001/0045459 A1
(43) Pub. Date: Nov. 29, 2001

(54) POS SYSTEM AND RECEIPT ISSUING METHOD

(76) Inventors: TAKAMASA KONDO, TOKYO (JP); MASAKI NAGAOKA, ANNAKA-SHI (JP)

Correspondence Address: STAAS & HALSEY LLP, 700 11TH STREET, NW, SUITE 500, WASHINGTON, DC, 20001, US

(21) Appl. No.: 09/271,251

(22) Filed: Mar. 17, 1999

(30) Foreign Application Priority Data
Aug. 31, 1998 (JP) 10-245043

(51) Int. Cl. G06K 15/00

(52) U.S. Cl. 235/383

(57) ABSTRACT

A POS system issues a receipt and prints messages, etc. including variable information for each transaction or for each customer on a receipt. The POS system is provided with an output information defining file to define output information such as promotion information, etc. In the output information defining file, a message information having an area to set, for example, a price reduction value (variable information) is defined. The output information is then read as required at the time of printing the receipt and a message is printed on the receipt by adding variable information.

### CROSS-REFERENCE TO RELATED APPLICATIONS

This application is based upon and claims priority of Japanese Patent Application No. 10-245043 filed Aug. 31, 1998, the contents being incorporated herein by reference.

### BACKGROUND OF THE INVENTION

The present invention relates to a Point of Sale (“POS”) system. More particularly, the present invention relates to a POS system for printing a message to a customer on a receipt issued for a transaction, and a receipt issuing method.

In recent years, retail promotion and competition have become more intensified, which in turn has prompted the offering of a discount by retailers and manufacturers to its customers. Such promotion is intended to raise the public image of a company as perceived by its potential and actual customers and to expand the scope of business. As one type of promotion vehicle, a promotional receipt is issued for each sales transaction.

FIG. 7 illustrates a structure of a conventional POS system 30 which issues a receipt. POS system 30 includes an input device 32 and an output device 34 which are respectively connected to a POS terminal 36. The input device 32 is illustrated with two separate unidirectional connections 32a and 32b to POS terminal 36, while output device 34 is connected to POS terminal 36 with a single unidirectional connection 34a. POS terminal 36 includes control unit 38 which is connected to input device 32, and item information defining file 40. An output of item information defining file 40 is in turn connected to control unit 38. As illustrated, control unit 38 includes a control program 42 to control operation.

FIG. 8 illustrates an example of a conventional receipt 50 which is issued from POS system 30 of FIG. 7. As illustrated in FIG. 8, receipt 50 includes a space 52 for printing a shopname of a shop. In the columns under space 52, a second space 54 for printing a commercial message is also provided. In the example of FIG. 8, a message such as “Thank you very much for shopping” is printed in space 54.

Underneath the second space 54, numerous items of information are also printed, including the date, an item name of an item which a customer has purchased, a price of the item purchased, a total amount of sales, an amount of exchange, and a name of the operator. A program for printing the receipt 50 is also included within control program 42 of POS system 30.

The commercial message printed on the receipt of FIG. 8 is a common message for each transaction. Moreover, as indicated in FIG. 8, receipt 50 includes the feature of a price reduction of, e.g. “−10” printed for “chocolate” and “−130” printed for “tuna sashimi.” Such a message for indicating the amount of a price reduction to be made for items is stored in the item information defining file 40 of POS terminal 36 (FIG. 7) along with the information of individual items. When a customer purchases, for example, “chocolate”, reference is made to the item information defining file 40 in the POS terminal 36 and reference is also made to the item information regarding “chocolate.” When the information for a price reduction is stored, such information is also read and it is then printed on the receipt.

However, as illustrated in FIG. 8, the commercial message shown in the second space 54 of conventional receipt 50 is a fixed message. Therefore, it has been difficult to output promotional information to customers which will change for each transaction. It has also been impossible to realize adequate promotion for each transaction and to realize adequate promotion directed toward each customer. Therefore it has been difficult to effectively realize an expansion of business.

### BRIEF SUMMARY OF THE INVENTION

It is therefore an object of the present invention to solve the above-mentioned problem by outputting variable promotional information to a customer for each transaction in order to raise an image of a company in the eyes of its customers.

It is a further object of the present invention to set an output message which will be printed on a receipt through an output information defining file. At the time of printing the receipt, output message information set to the output information defining file is read, and data is then printed on the receipt by editing the receipt printing information. The output message information is then printed on the receipt.

It is a further object of the present invention to print variable information for each transaction and each customer on a receipt as an output message by providing an area in which the variable information is set to be a part of the output message information, and then adding to this part specific information generated for each transaction.

Objects of the present invention are achieved by a POS system for issuing a receipt on which contents specific to a transaction are recorded for each transaction, including an input unit to input item discriminating information; an item information defining unit to store item information corresponding to the item discriminating information; an output information defining unit to store output message information to be printed on a receipt; a control unit to execute an account adjustment process by reading corresponding item information with reference to the item information defining unit on the basis of the item discriminating information input from the input unit; and an output unit to output a receipt including a result of the account adjustment process, whereby the control unit edits variable information in relation to the relevant transaction on the basis of the item information read from the item information defining unit, the output message information is read from the output information defining unit, the variable information is set to the output message information read from the item information defining unit, and the output message information including the variable information is output by the output unit.

Further objects of the present invention are achieved by a POS system for issuing a receipt on which contents of a transaction are recorded, including a control unit for executing an account adjustment process of a transaction on the basis of input item information; an output information defining unit to store output message information to be printed out on a receipt; and a printing unit to print out the receipt, whereby the control unit edits receipt printing information by reading output messages stored in the output defining unit when a receipt is issued and then adds variable information to the output message information, and a receipt on which the output message information is printed is issued by the printing unit on the basis of the edited receipt printing information.

Even further objects of the present invention are achieved by a method of issuing a receipt on which variable information related to each of a plurality of transactions is printed, including the steps of reading preset output message information at a time of issuing a receipt; setting variable information generated by a relevant transaction into the read output message information; and printing the output message information in which the variable information is set on a receipt.

Additional objects of the present invention are achieved by a method of issuing a receipt on which contents specific to a transaction are recorded for each transaction, including the steps of inputting item discriminating information; storing item information corresponding to the item discriminating information; storing output message information to be printed on a receipt; executing an account adjustment process by reading corresponding item information on the basis of the input item discriminating information; and outputting a receipt including a result of the account adjustment process, such that variable information in relation to the relevant transaction is edited on the basis of the read item information and the receipt includes the variable information.

### BRIEF DESCRIPTION OF THE DRAWINGS

These and other objects and advantages of the present invention will become apparent and more readily appreciated from the following description of the preferred embodiments, taken in conjunction with the accompanying drawings of which:

FIG. 1 is a block diagram of a POS system according to a preferred embodiment of the present invention.

FIG. 2 is a diagram of a printed receipt according to a preferred embodiment of the present invention.

FIG. 3 is a block diagram showing details of a POS system according to a preferred embodiment of the present invention.

FIG. 4 is a block diagram showing operation for a master setting of a POS system according to a preferred embodiment of the present invention.

FIG. 5 is a first schematic diagram showing operation for registration of a sales amount according to a preferred embodiment of the present invention.

FIG. 6 is a second schematic diagram showing operation for registration of a sales amount according to a preferred embodiment of the present invention.

FIG. 7 (PRIOR ART) is a block diagram of a conventional POS system of the related art.

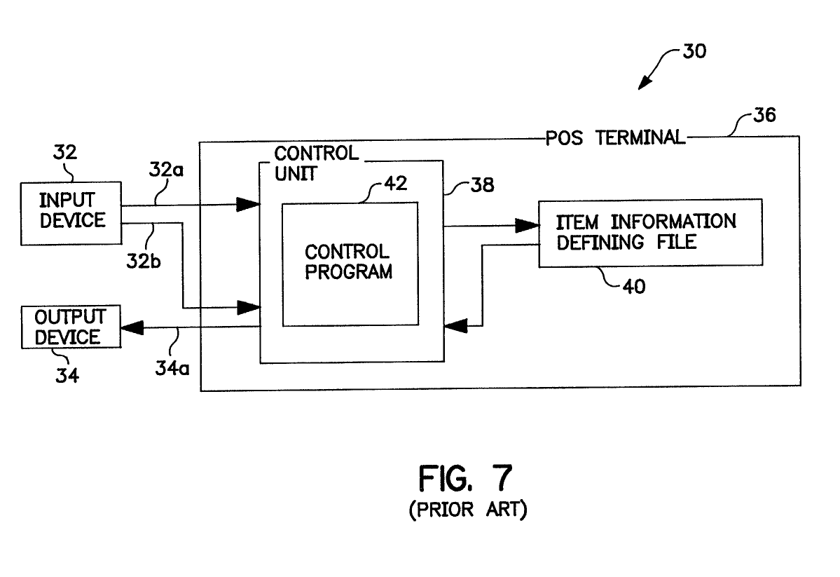

FIG. 8 (PRIOR ART) is a schematic diagram of a printed receipt according to the related art.

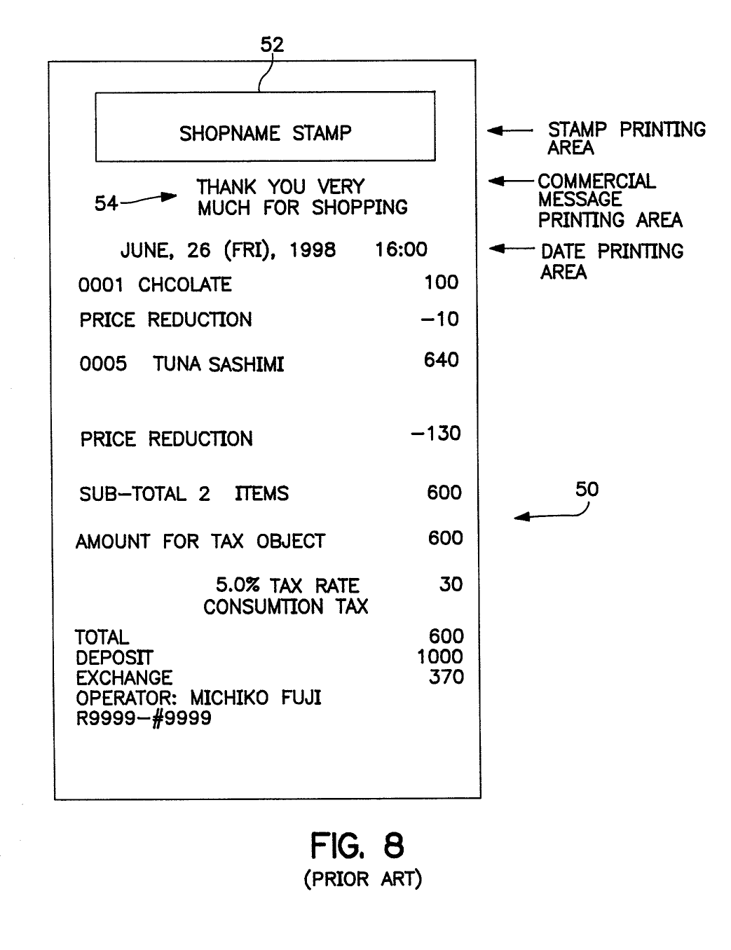

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

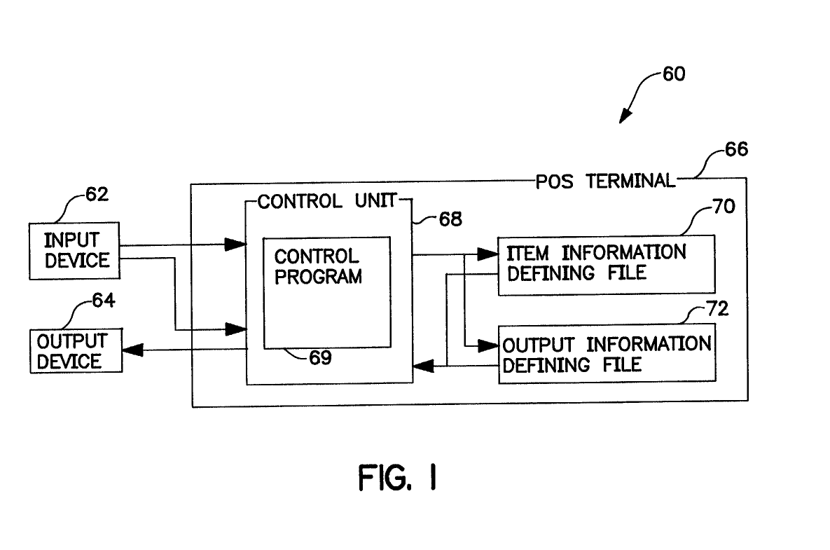

FIG. 1 is a block diagram showing a structure of a POS system 60 according to a preferred embodiment of the present invention. In FIG. 1, an input device 62 is formed as a keyboard or a bar code reader which can read bar codes printed items. An output device 64 is designed as a printer for printing a receipt.

The input device 62 and output device 64 are connected to a POS terminal 66 as part of the POS system 60. The POS system 60 operates by itself or through connection to a host computer or controller. In the example of FIG. 1, the host apparatus is not particularly shown.

POS terminal 66 has a function to accept a bar-code/item code input from input device 62, obtain an item price by searching the item information on the basis of the input item code, and calculate a total amount for each transaction. Therefore, the POS terminal 66 is provided with an item information defining file 70 for storing so-called item information such as an item name, and an item price of each item in correspondence to each item code. In FIG. 1, an example of the item information defining file 70 provided within POS terminal 66 is indicated.

This item information defining file may be provided in the host apparatus to which the POS terminal 66 is connected. In this case, the item information defining file 70 may be provided in the POS terminal 66 or not. POS terminal 66 also includes an output information defining file 72, which is connected to item information defining file 70 and control unit 68. Operation of the information defining file 72 is set forth below.

The POS terminal 66 is provided with control unit 68 for controlling adjustment of account within the POS terminal. This control unit is preferably formed of a microprocessor. A control program 69 is set within the microprocessor. According to this preferred embodiment, a promotional message is printed on a receipt which is issued from POS system 60.

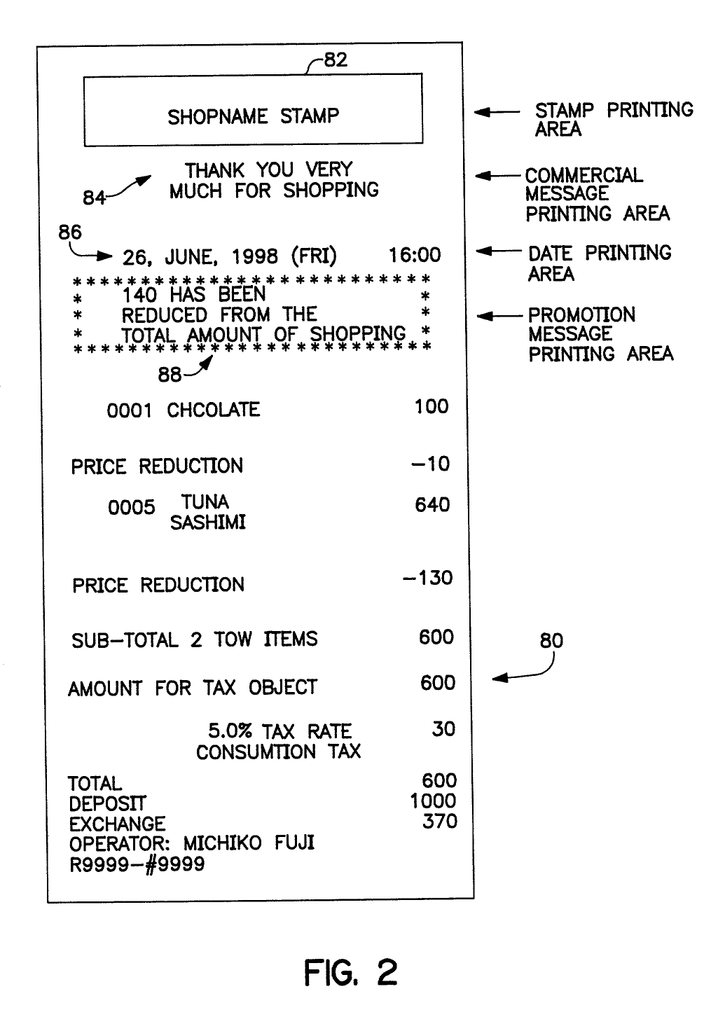

FIG. 2 is a diagram showing an example of a printed receipt 80 according to a preferred embodiment of the invention. At a leading area of receipt 80, a stamping area 82 is provided for the stamping/printing of a shop name. Stamping area 82 is designated as “SHOPNAME STAMP” and includes printing by a printer.

Under stamp area 82, a commercial message printing area 84 is set. In the example of FIG. 2, a commercial message of “THANK YOU VERY MUCH FOR SHOPPING” is printed. The commercial message in this embodiment is printed in a fixed manner.

Subsequently, a date printing area 86 is set on receipt 80. In the date printing area 86, the date and time of the transaction are printed.

Moreover, in the receipt of this preferred embodiment, a promotional message printing area 88 is set to print a promotional message. The promotional message includes variable information of each transaction. In the example of FIG. 2, a message of “140 HAS BEEN REDUCED FROM THE TOTAL AMOUNT OF SHOPPING” is printed.

Under the promotional message printing area 88, detailed contents of a point of sale transaction are printed. In more practical terms, item names, item prices, a number of items purchased, a sub-total amount, an amount of tax, a total amount, a deposited amount, and an amount of exchange are printed. In addition, when the items purchased are objects for price reduction, an amount of price reduction is printed for each item.

In the example of FIG. 2, a unit price of “Chocolate” is printed as “100” and an amount of a price reduction of “−10” is generated and also printed. Moreover, it is also indicated that “Tuna sashimi” has a unit price of “640” and a corresponding reduction amount of “−130”. An operator name is also printed at a lower portion of the receipt 80.

Here, an amount of price reduction is information which changes for each transaction depending on a class of items and a number of items purchased by a customer. In addition, even when the same item is purchased, such item is not included as the object of a price reduction or the price reduction rate is different depending on the date of shopping. Because of such a reason, the price reduction rate inevitably changes. Accordingly, the change in the price reduction rate requires a change in the promotional message which includes the price reduction rate as the variable information for each transaction.

Therefore, the promotional message of this embodiment is not written in a fixed manner within the control program for controlling the printing of receipt 80, but rather the promotional message information is set within the output information defining file. At the time of printing on the receipt, the control means (control program) refers to the output information defining file as required to read the promotional message information preset therein, then edits the printing information and then prints such information on the receipt 80.

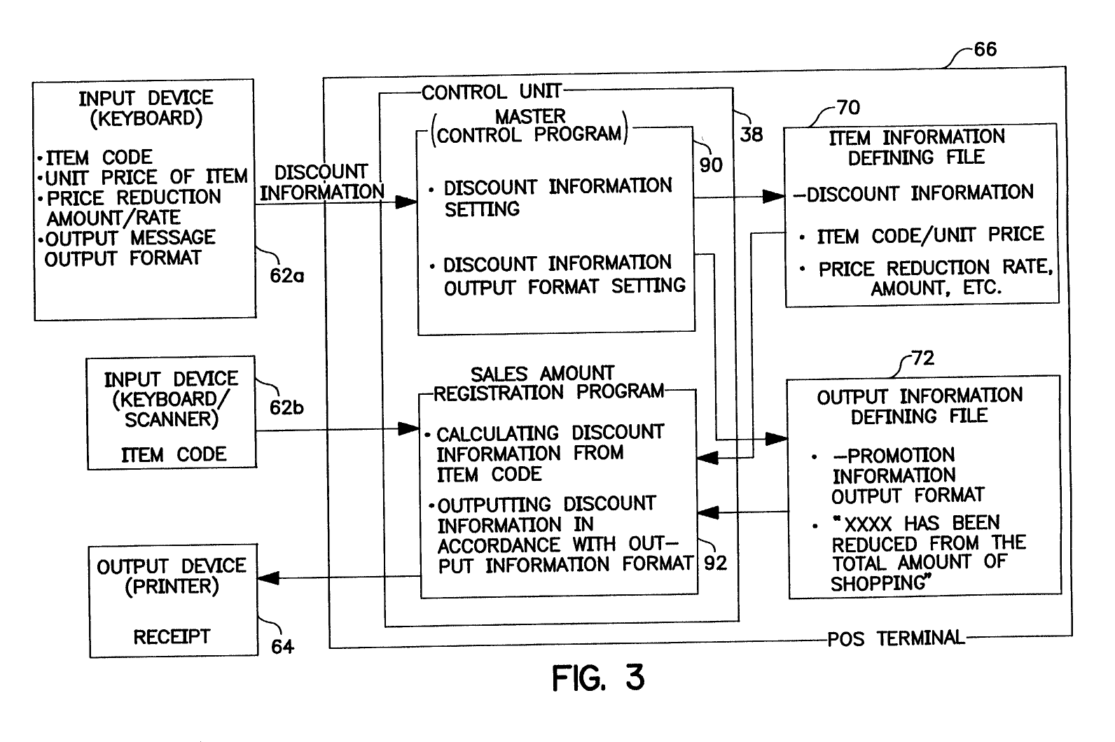

FIG. 3 is a diagram showing in greater detail the POS system 60 shown in FIG. 1. In the example of FIG. 3, the input device is defined as “Keyboard” 62a and “Keyboard/Scanner” 62b for each class of input object information. Input devices 62a and 62b are not necessarily different input devices. Particularly, the keyboard of the same type may be used as the keyboard.

In the example shown in FIG. 3, a master control program 90 and a sales amount registration program 92 are set in the control unit 38.

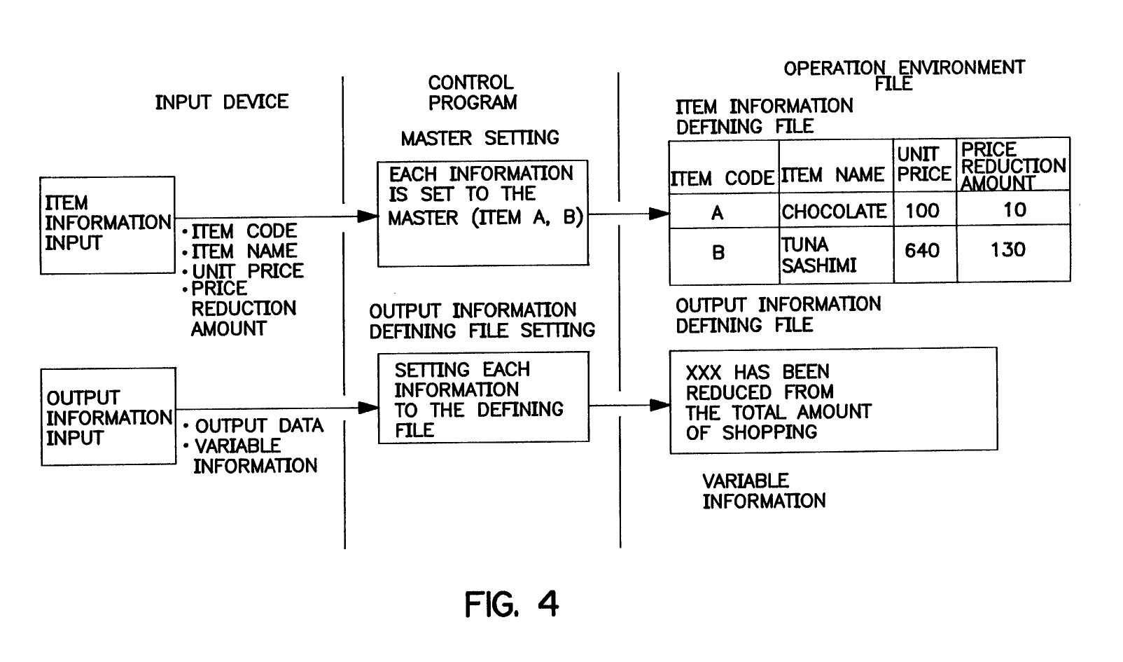

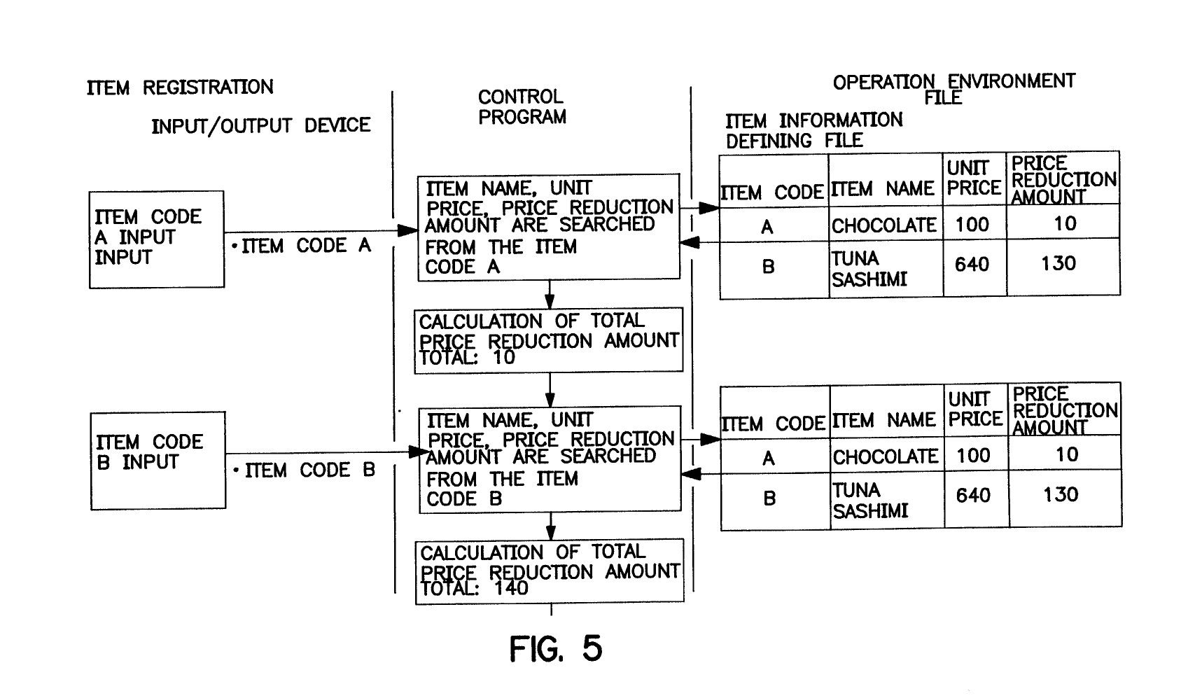

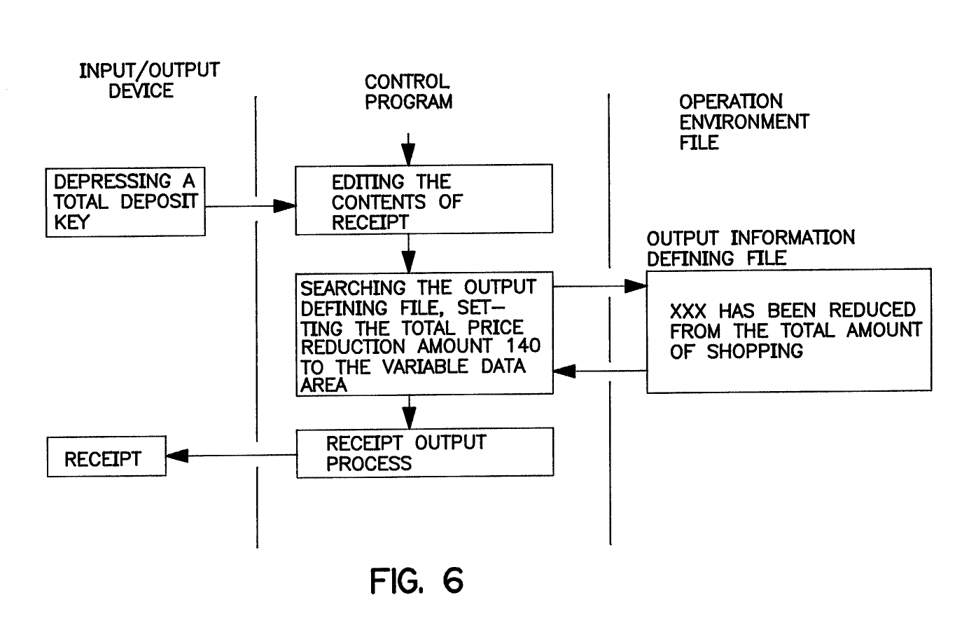

Collectively, FIG. 4, FIG. 5 and FIG. 6 show flowcharts for information and control among the input/output devices, the control program and an operation environment file (general name of the item information defining file and output information defining file) at the time of master setting and item registration. In particular, FIG. 4 shows operation for a master setting while FIG. 5 shows operation for item registration. Operations of this embodiment will then be explained with reference to these drawings.

The master setting program according to FIG. 4 operates for setting the information corresponding to the item information defining file 70 and output information defining file 72. In this case, item information, namely item code, unit price of item, and item name are input from the input device (e.g. a keyboard). The master setting program has a function to set and register the item information input from the keyboard to the item information defining file. Moreover, since the information about price reduction amount/price reduction rate is set for the items as the price reduction object, when such information is input, the master setting program registers such price reduction amount/price reduction rate to the item information defining file by considering it as a part of the item information.

FIG. 4 shows detailed contents of the item information defining file. In FIG. 4, an example of registering the item information corresponding to the items having the item code A and the item code B is indicated.

Corresponding to the item having the item code A, an item name of “Chocolate”, having a unit price “100”, and a price reduction amount “10” are registered to the item information defining file. In the same manner, corresponding to the item having the item code B, an item name “Tuna sashimi”, having a unit price “640” and a price reduction amount 130″ are registered.

Moreover, an output format of the promotional message is input from the keyboard. In the example of FIG. 3, since the output format “XXXX HAS BEEN REDUCED FROM THE TOTAL AMOUNT OF SHOPPING” is input, the output format input to the output information defining file is registered (FIG. 4). Here, “XXXX” is the variable information area. The reduction amount generated for each transaction is then set to the variable information area. Moreover, the other portion is the fixed message. The master setting program has a function to store the output format of the output message to be input to the output information defining file.

The sales amount registration program operates for each transaction. In this case, since an item code is input from the keyboard or scanner (bar-code reader), the sales amount registration program has a function to refer to the item information defining file based on the input item code, read the item information of the corresponding item, and execute registration of a sales amount and adjustment of account for the relevant transaction. Moreover, the sales amount registration program also has a function to read the price reduction information from the item information defining file in regard to the item for which the price reduction information (discount information) is preset and calculate the total price reduction amount in the relevant transaction.

Moreover, the sales amount registration program refers to the output information defining file and reads the output format of the promotional message registered therein. This program also sets the total amount of price reduction calculated to the variable information area (discount information area), edits the printing information and causes the output device to print the promotional message on the receipt by sending thereto the edited printing information.

The flow of a series of processes for item registration will now be explained with reference to FIG. 5 and FIG. 6. As illustrated, FIG. 6 is a diagram showing a continuation of FIG. 5.

First, when the item code A is input, the control program, namely the sales amount registration program, refers to the item information defining file on the basis of the input item code A and searches the item name, unit price, price reduction amount (when registered) of the item code A. Here, the item name “Chocolate”, unit price “100” and price reduction amount “10” corresponding to the item code A are searched.

The sales amount registration program then calculates a sub-total amount of sale of item of the relevant transaction corresponding to such searches. Here, the sub-total amount is “90” obtained by subtracting the price reduction amount of “10” from the unit price “100” of the Chocolate. Moreover, the sales amount registration program calculates a price reduction amount generated in the relevant transaction. Here, the total amount of price reduction of chocolate is “10”.

Subsequently, when the item code B is input from the input device, the sales amount registration program refers to the item information defining file based on the item code B and searches the corresponding item information. In this case, the item name “Tuna sashimi”, unit price “640” and price reduction amount “130” are searched.

Subsequently, the sales amount registration program calculates a sub-total amount of the relevant transaction. Here, a new sub-total amount of “600” can be obtained by adding the amount “510”, obtained by subtracting the price reduction amount of “130” from the unit price of “640” of tuna sashimi, to the sub-total of “90” calculated previously.

In the same manner, the sales amount registration program calculates and updates the total amount of price reduction. In more practical detail, the new updated total amount of price subtraction of “140” can be obtained by adding “130” which is the price reduction of tuna sashimi to the total amount of price reduction of “10” which is calculated previously.

When item registration of a transaction is completed, an operator depresses a total deposit key. Corresponding to depression of the total deposit key, the sales amount registration program calculates the total amount of a transaction and starts to edit the contents to be printed on the receipt. Here, the sales amount registration program searches the output information defining file to read the output format registered “XXXX HAS BEEN REDUCED FROM THE TOTAL AMOUNT OF SHOPPING”. Moreover, the total amount of the calculated price reduction of “140” is set to the variable information area “XXXX” (variable data area) of the output format. Subsequently, the sales amount registration program executes the receipt output process. Thereby, the promotional message including variable information is printed on the receipt.

With execution of the operation and process explained above, contents of the promotional message can be varied depending on the transaction in this embodiment. Moreover, since the promotional message is not the information written by the fixed manner into the program and stored in the output information defining file and moreover has the structure that the control program reads the promotional message from the output information defining file as required, contents of message can easily be changed by rewriting the message stored in the output information defining file. In this case, since rewriting of the program is not particularly required, the necessary information can easily be input, for example, before the shop opening time of a certain selected day.

Here, it is also possible that if price reduction is not generated for the items purchased by a customer, search of the output information defining file and reading of the output format by the sales amount registration program are not performed. In this case, the promotional message is not printed on the receipt.

In the embodiment explained above, only a kind of the message is stored in the output information defining file, but it is also possible to register a plurality of different messages. In the case of the example of FIG. 2, it is also allowed to store to the output information defining file the commercial message “Thank you very much for your coming”. Moreover, the other messages can also be registered.

As set forth above, according to the present invention, since the message information including variable information is stored in the file, variable information can particularly be printed on the receipt as required. Moreover, since a message information is registered into the file, message format can be changed more easily than that in the related art.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A POS system for issuing a receipt on which contents specific to a transaction are recorded for each transaction, comprising:
input means for inputting item discriminating information;
item information defining means for storing item information corresponding to the item discriminating information;
output information defining means for storing output message information to be printed on a receipt;
control means for executing an account adjustment process by reading corresponding item information with reference to said item information defining means on the basis of the item discriminating information input from said input means; and
output means for outputting a receipt including a result of the account adjustment process,
whereby said control means edits variable information in relation to the relevant transaction on the basis of the item information read from said item information defining means, the output message information is read from said output information defining means, the variable information is set to said output message information read from said item information defining means, and the output message information including the variable information is output by said output means.

2. The POS system as claimed in claim 1, wherein said item information defining means registers an amount of price reduction of each item and said control means calculates a total amount of price reduction of the items from the item information stored in said item information defining means, and defines the total amount of a price reduction calculated as the variable information.

3. The POS system according to claim 1, wherein said input means is a keyboard which inputs item discriminating information in the form of an item code, and said output means is a printer which prints the receipt.

4. The POS system according to claim 1, wherein said input means inputs an item code, a unit price of an item, a price reduction amount, an output message and an output format to said control means, and said control means calculates discount information from the unit price and the price reduction amount for each item and outputs the discount information to said output means as the variable information.

5. The POS system according to claim 1, further comprising:
an output information defining means for defining a promotion information output format to display the variable information and outputs the promotion information output format to said control means,
wherein said control means outputs said promotion information output format and the variable information to said output means.

6. The POS system as claimed in claim 5, wherein said item information defining means registers an amount of price reduction of each item and said control means calculates a total amount of price reduction of the items from the item information stored in said item information defining means, and defines the total amount of a price reduction calculated as the variable information.

7. The POS system according to claim 5, wherein said input means is a keyboard which inputs item discriminating information in the form of an item code, and said output means is a printer which prints the receipt.

8. The POS system according to claim 5, wherein the output information defining means is provided in a host apparatus which is connected to the POS terminal.

9. A POS system for issuing a receipt on which contents of a transaction are recorded, comprising:
a control unit for executing an account adjustment process of a transaction on the basis of input item information;
an output information defining unit to store output message information to be printed out on a receipt; and
a printing unit to print out the receipt,
whereby said control unit edits receipt printing information by reading output messages stored in said output defining unit when a receipt is issued and then adds variable information to said output message information, and a receipt on which said output message information is printed is issued by said printing unit on the basis of said edited receipt printing information.

10. The POS system as claimed in claim 9, further comprising:
an item information defining unit to register an amount of a price reduction of each item of the transaction,
wherein said control unit calculates a total amount of a price reduction of the items from the item information stored in said item information defining unit, and defines the total amount of a price reduction as the variable information.

11. The POS system according to claim 9, wherein said input unit is a keyboard which inputs item discriminating information in the form of an item code, and said output unit is a printer which prints the receipt.

12. The POS system according to claim 9, wherein said input unit inputs an item code, a unit price of an item, a price reduction amount, an output message and an output format to said control unit, and said control unit calculates discount information from the unit price and the price reduction amount for each item and outputs the discount information to said output unit as the variable information.

13. The POS system according to claim 9, further comprising:
an output information defining unit to define a promotion information output format to display the variable information and to output the promotion information output format to said control unit,
wherein said control unit outputs said promotion information output format and the variable information to said output unit.

14. A method of issuing a receipt on which variable information related to each of a plurality of transactions is printed, comprising the steps of:
reading preset output message information at a time of issuing a receipt;
setting variable information generated by a relevant transaction into the read output message information; and
printing the output message information in which said variable information is set on a receipt.

15. The method of issuing a receipt according to claim 14, further comprising the steps of:
inputting item discriminating information;
storing item information corresponding to the item discriminating information;
storing the output message information to be printed on a receipt; and
executing an account adjustment process by reading corresponding item information with reference to said item information discriminating information and printing a result of the adjustment process with the output message information on the receipt.

16. The method of issuing a receipt according to claim 15, further comprising the step of:
registering an amount of a price reduction for each of a plurality of items from the item discriminating information, and calculating a total amount of a price reduction of each of the plurality of items as the variable information.

17. The method of issuing a receipt according to claim 15, wherein said inputting step inputs the item discriminating information with a keyboard in the form of an item code, and said printing steps prints the output message information with a printer.

18. The method of issuing a receipt according to claim 15, further comprising the step of:
defining a promotion information output format to display the variable information such that said printing step prints the variable information in the promotion information output format.

19. The method of issuing a receipt on which contents specific to a transaction are recorded for each transaction, comprising the steps of:
inputting item discriminating information;
storing item information corresponding to the item discriminating information;
storing output message information to be printed on a receipt;
executing an account adjustment process by reading corresponding item information on the basis of the input item discriminating information; and
outputting a receipt including a result of the account adjustment process, such that variable information in relation to the relevant transaction is edited on the basis of the read item information and the receipt includes the variable information.

20. The method of issuing a receipt according to claim 19, further comprising the step of:
defining a promotion information output format to display the variable information such that the receipt includes the variable information in the promotion information output format.
